(19) United States
(12) Patent Application Publication
(10) Pub. No.: US 2005/0029231 A1
(43) Pub. Date: Feb. 10, 2005

(54) Drilling apparatus for drip irrigation tubes

(75) Inventors: Eberhard Kertscher, Yvonand (CH); Thomas Bernauer, Neuchatel (CH)

Correspondence Address: David J. Brezner;Dorsey & Whitney LLP, Intellectual Property Department, Four Embarcadero Center, Suite 3400, San Francisco, CA, 94111-4187, US

(73) Assignee: Eberhard Kertscher

(21) Appl. No.: 10/881,965

(22) Filed: Jun. 29, 2004

(30) Foreign Application Priority Data
Aug. 8, 2003 (EP) 03405609.3

(51) Int. Cl. B23H 1/00

(52) U.S. Cl. 219/68

(57) ABSTRACT

A drilling apparatus for making holes in a tube body in the area of metering elements comprises drilling means which are disposed on a framework. Via sensor means, the position of the metering elements in the tube body are ascertained. Based upon a signal triggered thereby, the drilling operation is carried out. For this purpose, the tube body is led over a roller which is rotatingly held on the framework. The tube body to be drilled wraps around the roller around an area and is then led away. In this wrap-around area, in which the tube body rests upon the roller, the position of the metering means in the tube body is ascertained by the sensor means; the holes can then be made. The making of these holes can take place very precisely since the tube body cannot undergo any longitudinal stretching when it is resting on the roller.

The present invention relates to a drilling apparatus for drip irrigation tubes, comprising drilling means disposed on a framework, feeding means by means of which the extruded drip irrigation tubes provided with metering elements can be fed to the drilling means for making the holes in the tube body in the area of the metering elements and thereafter be taken away therefrom, sensor means for ascertaining the position of the metering elements in the tube body, as well as control means for controlling the drilling operation.

With such drip irrigation tubes, a direct irrigation of plants can be achieved. These drip irrigation tubes are so manufactured and designed that, for example, in the area of each plant there is a metering element through which the water is let out of the drip irrigation tube in drops through a hole. Each of the individual plants is thereby directly irrigated, the water consumption is very economical. In particular, it is avoided that a large quantity of the water for irrigation evaporates, as usually happens in irrigation systems where the water is distributed over a large area by sprays. By means of the drip irrigation through these drip irrigation tubes, a very economical irrigation is achieved.

Drilling apparatus for drip irrigation tubes, by means of which holes are made in the tube wall in the area of the metering elements for enabling water to come out of the tube body, have been disclosed. Thus, for example, EP-A-715 926 shows such an apparatus. After extrusion of the tube and insertion of the metering elements in this tube, the tube passes by a touchless sensor by means of which the beginning and/or the end of a metering element can be ascertained. After running through the sensor, the tube is pulled through a drilling apparatus by means of a pulling apparatus disposed behind the drilling apparatus. Based upon the signal transmitted by the sensor, and knowing the advancing speed of the tube, the respective drilling apparatus is activated, and the hole is drilled. The tube is then wound in a winding device.

The tube body of such drip irrigation tubes is made, for example, on the basis of polyethylene. Particularly in the case of thin-walled tubes, as are used, for instance, when annuals are to be watered and the drip irrigation tubes are laid on the surface and must be replaced after the one-time use, longitudinal stretching is to be expected upon slight pulling because of the elasticity. Since, in the above-mentioned prior art apparatus, there is a relatively great distance between the sensor, the drilling apparatus, and the pulling apparatus, it is not out of the question that a modification of the length of such a tube occurs. As a result, the hole may not be made at the right location in the area of the metering element, whereby the tube, or at least that section, becomes unusable. In addition, it is relatively difficult to guide the tube body having a circular cross-section in such a way that no twisting takes place on the processing length. The result of such twisting would likewise be that the hole cannot be made at the correct position in the area of the metering element, with the consequences mentioned above.

It is now the object of the present invention to provide a drilling apparatus for drip irrigation tubes which guarantees that the hole is made in the tube body in the correct position in the area of the metering element, as regards both the longitudinal direction and the transverse direction.

According to the present invention, this object is achieved in that a roller rotatable about an axis of rotation is affixed in the framework, on which roller the tube body supplied, pressed flat after extrusion and insertion of the metering elements, is laid, it wraps around at least one area of the roller and is then carried away, that in the wrap-around area in which the tube body rests upon the roller, the position of the metering means in the tube body is ascertainable by means of the sensor means, and the holes can be made by the drilling means.

By pressing the tube body flat or briefly deforming it after extrusion and insertion of the metering elements, it is ensured that the tube body cannot twist during the further processing operation; the tube body exhibits essentially the shape of a strip which can be optimally guided. Inasmuch as the tube body wraps around the roller of the drilling apparatus in at least one area, with both the sensor means ascertaining the position of the metering means in the tube body and the holes being producible by the drilling means in this wrap-around area, a change in length as a result of stretching of the tube body is prevented from occurring; the holes may thus be made very exactly.

Advantageously, two guide rollers are affixed to the framework of the inventive drilling apparatus in such a way that the tube body is introduced onto the roller in a marginal area of the roller, then laid around the first guide roller, goes from there to the middle area of the roller on which it forms a middle wrap-around area, is led around the second guide roller, reaches the other marginal area of the roller, and is led out of the drilling apparatus. By means of this arrangement, it is achieved that the middle wrap-around area is substantially about 180ø, that the tube body is led over the roller and the first guide roller into this middle wrap-around area and is led on again guided accordingly. Through the long supporting of the tube body on the roller, any change in length in the drilling direction during the processing operation is eliminated. In addition, the tube body is led out of the drilling apparatus in the same direction as when it was fed in. Hence there are no problems of space for further processing stations.

For optimizing the contact between the roller and the tube body, the surface of the roller may be provided with a no-slip coating.

In order to be able to use the optimum wrap-around conditions of the tube body around the roller, the sensor means and the drilling means are so disposed in the drilling apparatus that they are aligned with the middle wrap-around area of the tube body on the roller.

In an advantageous design of the invention, the sensor means consist of a sender-key contact which is affixed freely rotatingly on a swivel lever and rests upon the tube body; this swivel lever carries out a swivel movement each time a metering element affixed in the tube body passes under the sender-key contact and thereby triggers a signal which can be supplied to the control means. The metering element forms an elevation in the tube body which can be perceived from the outside. Through the curvature of the surface of the roller and the rigidity of the metering element affixed in the tube body, the front and back ends of the metering element stand out more obviously from the tube body, whereby the swivel movement of the swivel lever is still more pronounced by the sender-key contact, and the position of the metering element in the tube body can be exactly determined.

In a further advantageous design of the invention, the drilling means are facilities for preparing and transmitting laser beams, these facilities being disposed behind the sensor means on the framework, viewed in the direction of advance of the tube body.

In a further advantageous design of the invention, checking means are affixed behind the drilling means, as viewed in the direction of advance of the tube body, for checking the position of the holes made in the tube body relative to the metering elements. With these checking means, optimum quality of the drip irrigation tubes thus produced is guaranteed.

An embodiment of the present invention will be described below, by way of example, with reference to the accompanying drawing.

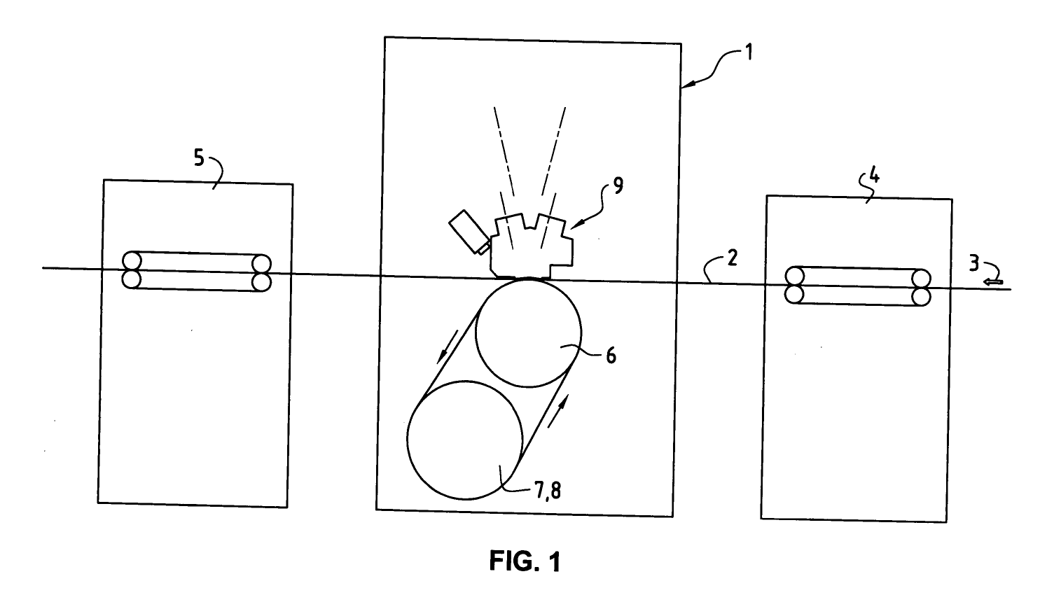

FIG. 1 is a diagrammatic representation of an inventive drilling apparatus, a pulling apparatus being disposed in front of and behind this drilling apparatus, respectively;

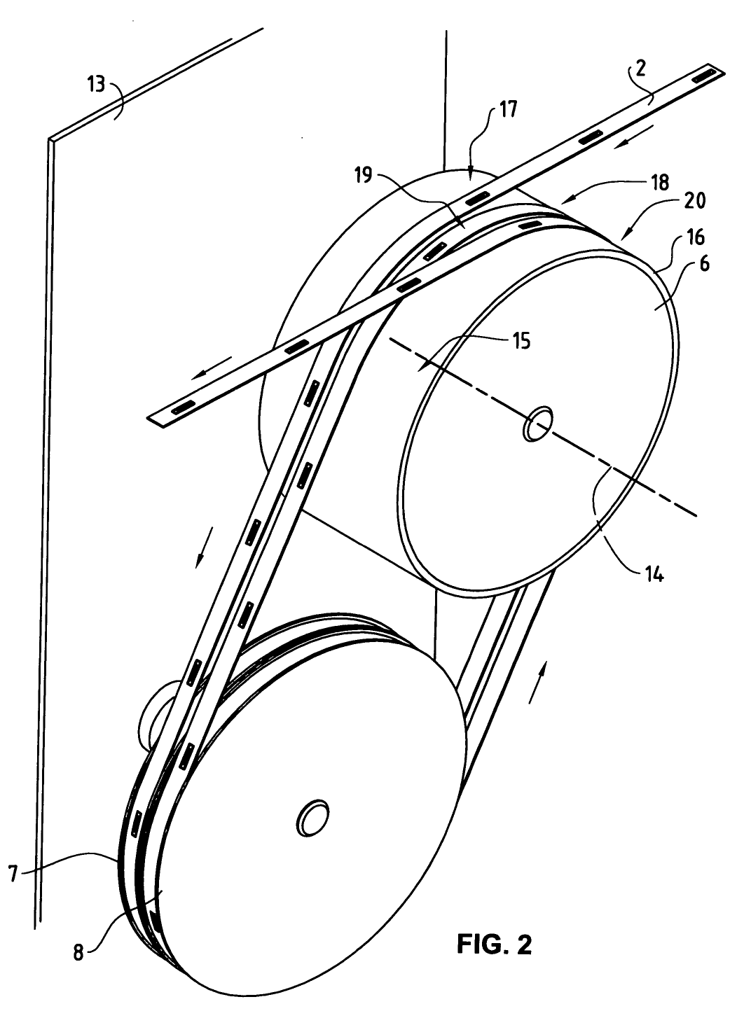

FIG. 2 is a perspective view of the arrangement of the roller and the guide rollers in the drilling apparatus, as well as the guidance of the tube body over this roller and the guide rollers;

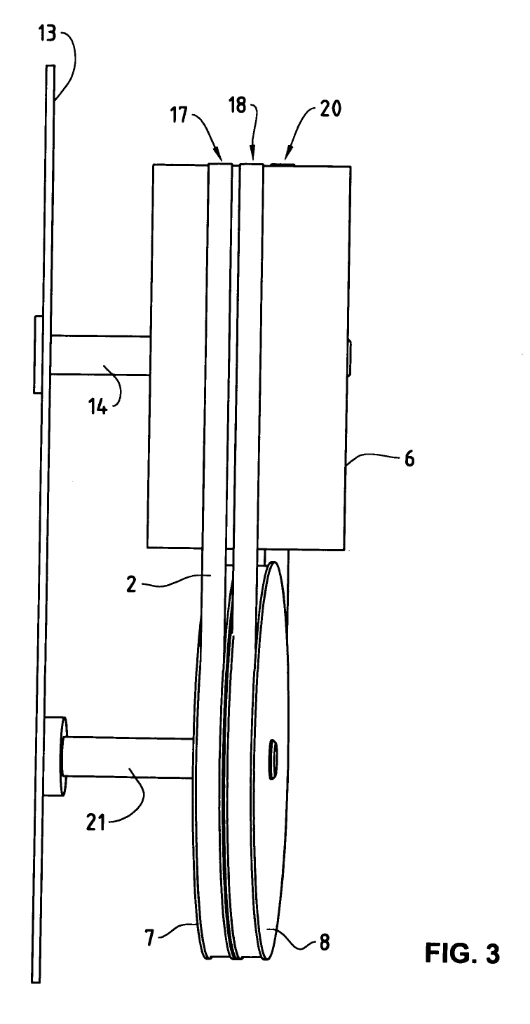

FIG. 3 is a front elevation of the roller and the guide rollers of the drilling apparatus;

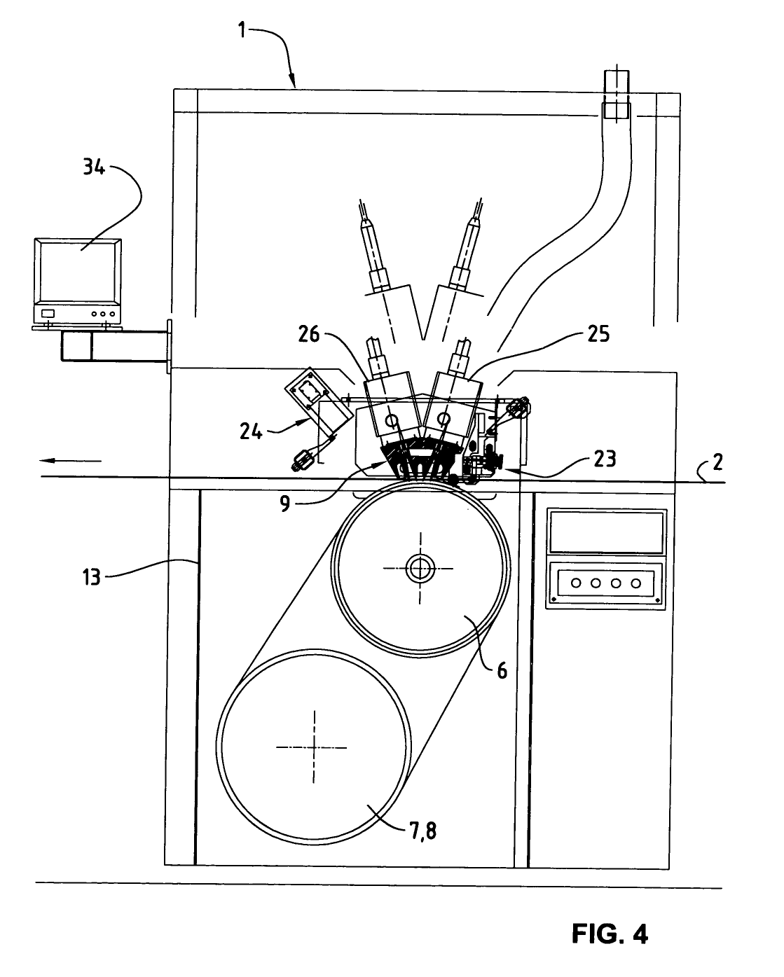

FIG. 4 is an elevation of the inventive drilling apparatus with the arrangement of the drilling means, the sensor means, and the checking means;

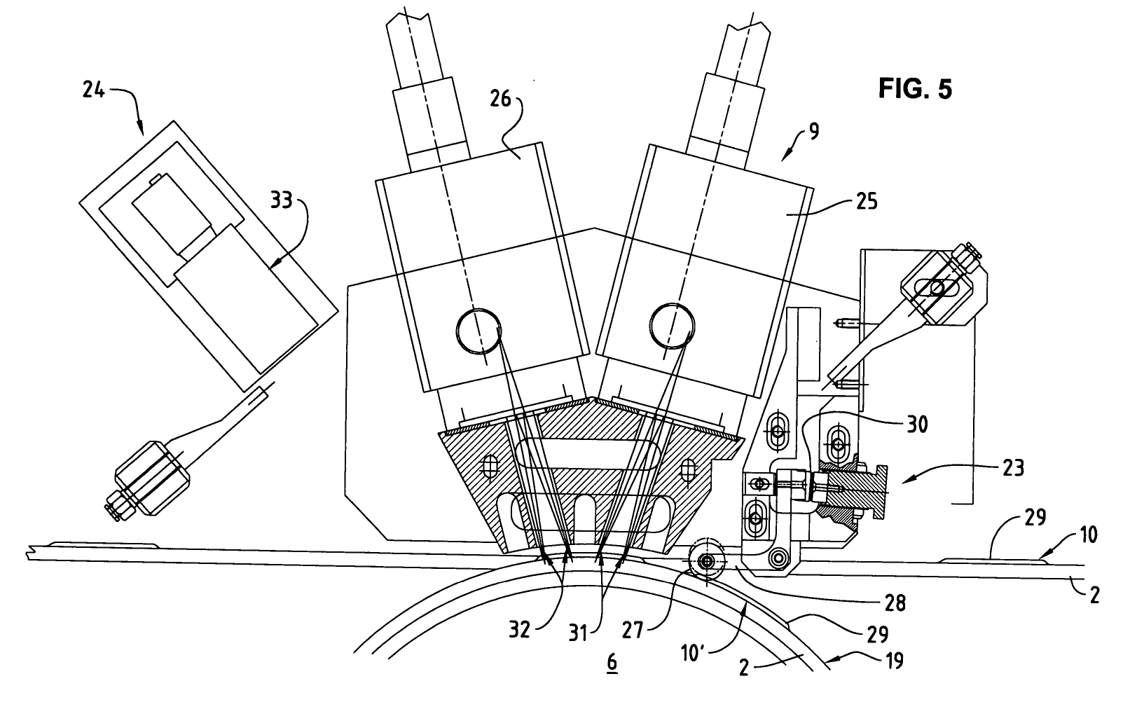

FIG. 5 is a view of the drilling means, the sensor means,
and the checking means; and

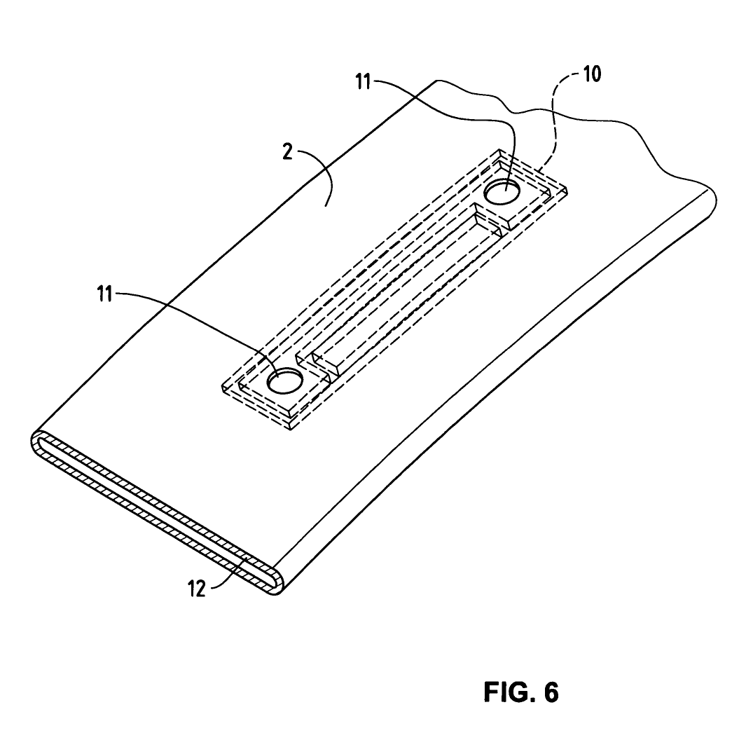

FIG. 6 is a perspective view of a detail of a drip irrigation tube.

As may be seen in FIG. 1, the flat-pressed tube body 2 is continuously fed to a drilling apparatus 1 in the direction of the arrow 3. On this occasion, the tube body 2 passes through a first feeding apparatus 4, is then led through the drilling apparatus 1 and removed from the drilling apparatus 1 over a second feeding apparatus 5. The advancing speeds of these feeding apparatus 4 and 5 are so chosen that the tube body 2 is kept optimally taut in the drilling apparatus 1. As will be described below, the tube body 2 supplied to the drilling apparatus 1 runs around a roller 6 and guide rollers 7 and 8 and is thus led past the drilling means 9.

In a manner known per se, the tube body 2, as it is shown in FIG. 6, is obtained by means of an extrusion operation, the metering elements 10 then being inserted. The tube body 2 is then pressed together so that the tube body 2 takes the form of a strip. This pressing together takes place immediately after the extrusion operation and the insertion of the metering elements 10 in the tube body 2, thus ensuring that the metering elements 10 are always disposed in the middle within the tube body 2 in longitudinal direction. While the tube body 2 is passing through the drilling apparatus 1 (FIG. 1), which takes place at a speed of about 3 m/s, for example, the holes 11 are made in the wall 12 of the tube body 2, through which the water can come out drop by drop when used for irrigation. The tube body 2 is made, for example, of polyethylene, the wall 12 of the tube body 2 is about 0.1 to 2 mm thick, for example; during the irrigation operation the tube body is pushed out by the pressure of the water inside, so that it takes on a virtually round cross-sectional shape.

FIG. 2 shows the arrangement of the roller 6 and the guide rollers 7 and 8 on the framework 13 of the drilling apparatus 1. The roller is rotatable about an axis of rotation 14, has a cylindrical surface 15 and a width corresponding to several times the width of the tube body 2. The cylindrical surface 15 of the roller 6 may be provided with a no-slip coating 16, e.g., of rubber. In the exemplary embodiment shown here, the tube body 2 is introduced onto the roller 6 in a rear marginal area 17 of the roller 6. The tube body is deviated and is laid about the first guide roller 7. From here, the tube body returns to the roller 6; because the first guide roller 7 is positioned at an angle, as may be seen in FIG. 3, the tube body reaches a middle area 18 of the roller 6 and forms a middle wrap-around area 19. From here, the tube body goes onto the second guide roller 8, is deviated here, and likewise because this second guide roller 8 is positioned at an angle, as may be seen from FIG. 3, it is led back to the front marginal area 20 of the roller 6. Thereafter, the tube body is led away from the roller 6 and reaches the second feeding apparatus 5, as is seen in FIG. 1.

The roller 6 is driven by the tube body 2 pulled through the feeding apparatus 4 and 5, so that the tube body 2 is kept optimally taut while passing through these two feeding apparatus 4 and 5 and the roller 6 and the two guide rollers 7 and 8. Here the two guide rollers 7 and 8 may be mounted to rotate freely on the axle 21.

By means of this arrangement, it is achieved that the tube body 2 rests completely unslippably on the roller 6, especially in the middle wrap-around area 19. Thus, the tube body 2 undergoes here absolutely no change in length although it is made of a material which is in itself elastic.

As may be seen in FIG. 4, the drilling means 9, the sensor means 23, and the checking means 24 are disposed on the framework 13 of the drilling apparatus 1 in such a way that they are aligned with the middle wrap-around area 19 (FIGS. 2 and 3). The drilling means 9 consist of a first facility 25 and a second facility 26 for producing laser beams. Drilling means 9, sensor means 23, and checking means 24 are connected in a manner known per se, not illustrated, to control means disposed in the drilling apparatus 1.

FIG. 5 shows an enlarged view of the arrangement of the drilling means 9, the sensor means 23, and the checking means 24. The sensor means 23 comprise a sender-key contact 27, which here takes the form of a keying roller disposed for free rotation on a swivel lever 28. However, a sliding contact might also be used. This keying roller 27 rests on the tube body 2 which forms the middle wrap-around area 19 (FIGS. 2 and 3). The metering elements 10 inserted the tube body 2 form an elevation 29 in the surface of the tube wall. Particularly in the middle wrap-around area 19, the front edge and the rear edge of the metering element 10 rise still farther out of the surface of the tube body 2 because of the curvature of the surface of the roller 6.

Upon the passage of such a metering element 10′ in the area of the keying roller 27 of the sensor means 23, this roller is lifted by the front edge of the elevation 29. This causes the swivel lever 28 to swivel; affixed to the end portion of this swivel lever 28 remote from the keying roller 27 is a sensor 30 by means of which the swiveling can be ascertained and which transmits a signal to the control means of the drilling apparatus 1. By means of these sensor means 23, it can therefore be exactly ascertained when a metering element 10 is disposed in the tube body.

Disposed at a precisely given distance from the keying roller 27 are the first facility 25 and the second facility 26 for preparing and transmitting laser beams. By means of these facilities 25 and 26, the holes 11 are made in the wall 12 of the tube body 2, as may be seen in FIG. 6.

In a manner known per se, the roller 6 is equipped with an incremental generator; after transmission of a signal by the sensor means 23 to the control means, a precisely given number of incremental steps are taken, whereafter the first facility 25 and the second facility 26 for preparing and transmitting the laser beams are activated. Since, in the present exemplary embodiment, two holes 11 are to be made per metering element 10, they are drilled simultaneously. Of course, it is also conceivable that metering elements having only one hole are affixed; then only one of the two facilities 25 and 26 is activated.

In addition, the speed of advance of the tube body 2, hence the speed of rotation of the roller 6, is measured. This is used for the purpose that the laser beams 31 and 32 of the first facility 25 and the second facility 26 can go along with the advancing tube body 2 during the drilling operation. For this, in a manner known per se, mirrors are provided which are swiveled during the drilling operation synchronously with the speed of advance of the tube body 2, whereby the laser beams 31 and 32 go along. In FIG. 5, the front and rear end positions of each of the laser beams 31 and 32 are shown diagrammatically. In a manner known per se, the laser beams are effective until the tube wall is pierced without the metering elements 10 disposed thereunder being destroyed.

The facilities 25 and 26 for generating laser beams are, for example, of the Nd/YAG or carbon dioxide type. Of course, it would also be conceivable to use other suitable types of laser.

After the holes have been made in the tube body 2 in the area of the metering elements 10, the latter are checked by the checking means 24. These checking means consist in the present exemplary embodiment of a camera 33 which takes a picture of each passing metering element 10 with the holes 11 made. This picture taken corresponds substantially to the illustration shown in FIG. 6. The elevations 29 formed by the metering element 10 in the wall 12 of the tube body 2 form a relatively sharp outline which is clearly recognizable in the picture taken; the positions of the holes 11 can then be precisely recognized relative to the metering element in this picture. The image thus obtained is supplied to the control means; it is then ascertained whether the positions of the holes 11 are correct. The pictures taken may additionally be shown on a monitor 34 (FIG. 4) for viewing.

If a deviation of the position of the holes 11 relative to the metering elements 10 is found, an automatic adjustment may be carried out.

By means of this drilling apparatus according to the invention, the holes can be made very exactly in the wall of a tube body in the area of the metering elements while the tube body is continuously advancing. Between ascertaining the presence of a metering element in the tube body by the sensor means up to the drilling means, absolutely no change in length takes place of the basically longitudinally elastic tube body, so that drilling can take place very exactly. Through the ascertaining of the presence of a metering element by the sensor means and the subsequent drilling of the holes, it does not matter how far apart the metering elements disposed one behind the other in the tube body are spaced, so that this spacing may vary. Drip irrigation tubes can thereby be produced which fulfill the given requirements; e.g., for irrigating fruit trees in orchards, drip irrigation tubes are used which have several metering elements disposed close to one another in the area of the trees, whereas there is a greater distance between them.

1. Drilling apparatus for drip irrigation tubes, comprising drilling means disposed on a framework, feeding means by means of which the extruded drip irrigation tubes provided with metering elements can be fed to the drilling means for making the holes in the tube body in the area of the metering elements and thereafter be taken away therefrom, sensor means for ascertaining the position of the metering elements in the tube body, as well as control means for controlling the drilling operation, wherein a roller rotatable about an axis of rotation is affixed in the framework, on which roller the tube body supplied, pressed flat after extrusion and insertion of the metering elements, is laid, it wraps around at least one area of the roller and is then carried away, that in the wrap-around area in which the tube body rests upon the roller, the position of the metering means in the tube body is ascertainable by means of the sensor means, and the holes can be made by the drilling means.

2. Drilling apparatus according to claim 1, wherein the roller has a cylindrical surface and a width which corresponds to several times the width of the tube body.

3. Drilling apparatus according to claim 2, wherein two guide rollers are affixed to the framework in such a way that the tube body is introduced onto the roller in a marginal area of the roller, is then laid around the first guide roller, goes from there to the middle area of the roller on which it forms a middle wrap-around area, is led around the second guide roller and reaches the other marginal area of the roller, and is led out of the drilling apparatus.

4. Drilling apparatus according to claim 1, wherein the surface of the roller is provided with a no-slip coating.

5. Drilling apparatus according to claim 3, wherein the sensor means and the drilling means are so disposed in the drilling apparatus that they are aligned with the middle wrap-around area of the tube body on the roller.

6. Drilling apparatus according to claim 1, wherein the sensor means consist of a sender-key contact which is affixed to a swivel lever and rests upon the tube body, which swivel lever carries out a swivel movement each time a metering element affixed in the tube body passes under the sender-key contact and thereby triggers a signal which can be supplied to the control means.

7. Drilling apparatus according to claim 1, wherein the drilling means are facilities for preparing and transmitting laser beams, which facilities are disposed behind the sensor means on the framework as viewed in the direction of advance of the tube body.

8. Drilling apparatus according to claim 6, wherein the drilling operation can be triggered controlled by the control means dependent upon the signal which the control means receive from the sensor means.

9. Drilling apparatus according to claim 7, wherein the drilling operation can be triggered controlled by the control means dependent upon the signal which the control means receive from the sensor means.

10. Drilling apparatus according to claim 7, wherein the facilities for preparing and transmitting the laser beams are so designed that the laser beams hitting the tube body during the drilling operation go along with the advancing tube body.

11. Drilling apparatus according to claim 8, wherein the facilities for preparing and transmitting the laser beams are so designed that the laser beams hitting the tube body during the drilling operation go along with the advancing tube body.

12. Drilling apparatus according to claim 9, wherein the facilities for preparing and transmitting the laser beams are so designed that the laser beams hitting the tube body during the drilling operation go along with the advancing tube body.

13. Drilling apparatus according to claim 1, wherein checking means are affixed behind the drilling means as viewed in the direction of advance of the tube body, by means of which checking means the position of the holes drilled in the tube body can be checked and adjusted relative to the metering elements.
